(19) United States
(12) Patent Application Publication
(10) Pub. No.: US 2025/0336203 A1
(43) Pub. Date: Oct. 30, 2025

(54) METHOD AND APPARATUS FOR COMPENSATING BACKLIGHT BY USING TOLERANCE INFORMATION

(71) Applicants: HYUNDAI MOTOR COMPANY, Seoul (KR); KIA CORPORATION, Seoul (KR)

(72) Inventor: Soo Hun Kwon, Yongin-si (KR)

(73) Assignees: HYUNDAI MOTOR COMPANY, Seoul (KR); KIA CORPORATION, Seoul (KR)

(21) Appl. No.: 18/972,240

(22) Filed: Dec. 6, 2024

(30) Foreign Application Priority Data
Apr. 25, 2024 (KR) 10-2024-0055686

(51) Int. Cl. G06V 10/98; G06V 10/25; G06V 10/26; G06V 10/50; G06V 10/60; G06V 10/764; G06V 20/56

(52) U.S. Cl. CPC G06V 10/993; G06V 10/25; G06V 10/26; G06V 10/50; G06V 10/60; G06V 10/764; G06V 20/56

(57) ABSTRACT

A backlight compensation apparatus includes at least one memory; and at least one processor. By executing instructions, the at least one processor is configured to: receive images from a camera by an in-vehicle system, estimate a position of horizon in the images using intrinsic and extrinsic parameters of the camera, set a region of interest (ROI) based on the position of the horizon, partition the ROI into a plurality of blocks and measure an average luminance value for each of the plurality of blocks, group the blocks into a plurality of block groups based on the average luminance value of each block, determine a backlight condition of the ROI according to a predetermined average luminance value for each block among the plurality of block groups, and adjust a plurality of block luminance values according to the backlight condition of the ROI.

### CROSS-REFERENCE TO RELATED APPLICATION

This application claims the benefit of and priority to Korean Patent Application No. 10-2024-0055686, filed on Apr. 25, 2024 in the Korea Intellectual Property Office, the entire contents of which are incorporated herein by reference.

### TECHNICAL FIELD

The present disclosure relates to a method and an apparatus for compensating backlight using automated tolerance information.

### BACKGROUND

The content described below simply provides background information related to the present embodiment and does not constitute the prior art.

With advancements in autonomous driving technology, various camera-based image recognition systems are being used in vehicles to recognize their surroundings. However, backlight may be generated due to the presence of various light sources around the vehicle. Images captured in backlight conditions are difficult to interpret because the brightness of some area, such as white holes, is distorted. In particular, recognition performance deteriorates for vehicles equipped with wide-angle cameras, because these cameras are frequently exposed to diverse backlight conditions. This reduces a driver's visibility in dark areas under backlight conditions and limits the recognition performance of autonomous driving and parking systems.

To address the problem due to backlight, many methods have been proposed to detect and correct backlight images in photos or videos. However, conventional methods are based on software-based approaches capable of dealing with limited situations, such as backlighting and light blur. For example, histogram equalization (HE) operates unconditionally across the global domain or region of interest (ROI) of an image. In other words, because conventional contrast enhancement methods operate in the frequency domain or in a pixel-wise manner, their correction performance deteriorates when there is a problem with the backlight image itself.

### SUMMARY

The present disclosure aims to provide corrected images by improving capability of recognizing the solar light source by segmenting regions of interest belonging to the sky region, accurately recognizing the solar light source in the segmented regions of interest, and then performing backlight compensation.

The technical objects of the present disclosure are not limited to those described above, and other technical objects not mentioned above may be understood clearly by those having ordinary skill in the art from the descriptions given below.

An embodiment of the present disclosure provides an apparatus for a backlight compensation apparatus includes at least one memory; and at least one processor. By executing instructions, the at least one processor is configured to: receive images from a camera by an in-vehicle system, estimate a position of horizon in the images using intrinsic and extrinsic parameters of the camera, set a region of interest (ROI) based on the position of the horizon, partition the ROI into a plurality of blocks and measure an average luminance value for each of the plurality of blocks, group the blocks into a plurality of block groups based on the average luminance value of each block, determine a backlight condition of the ROI according to a predetermined average luminance value for each block among the plurality of block groups, and adjust a plurality of block luminance values according to the backlight condition of the ROI.

According to an embodiment of the present disclosure, a method for implementing a backlight compensation apparatus includes: receiving images from a camera by an in-vehicle system; estimating a position of horizon in the image using intrinsic and extrinsic parameters of the camera; setting a region of interest (ROI) based on the position of the horizon; partitioning the ROI into a plurality of blocks and measure an average luminance value for each of the plurality of blocks; grouping the blocks into a plurality of block groups based on the average luminance value of each block; determining a backlight condition of the ROI according to a predetermined average luminance value for each block among the plurality of block groups; and adjusting a plurality of block luminance values according to the backlight condition of the ROI.

According to one embodiment of the present disclosure, the accuracy of recognizing the solar light source may be improved by segmenting only the regions of interest corresponding to the sky region and applying more specific conditions within the same resources.

The user's ability to intuitively recognize a parking environment may be improved by performing brightness correction on images affected by backlighting in a parking or driving environment and improving the visibility in dark areas.

Image recognition performance for objects such as pedestrians, motorcycles, and lanes in dark areas under backlight conditions may be improved.

The technical effects of the present disclosure are not limited to the technical effects described above, and other technical effects not mentioned herein may be understood to those having ordinary skill in the art to which the present disclosure belongs from the descriptions below.

### BRIEF DESCRIPTION OF THE DRAWINGS

FIG. 1 is a block diagram briefly illustrating a backlight compensation apparatus according to an embodiment of the present disclosure.

FIG. 2 is a block diagram illustrating an automated tolerance compensation system according to an embodiment of the present disclosure.

FIG. 3 is a block diagram illustrating an image processing system according to an embodiment of the present disclosure.

FIG. 4 is a block diagram illustrating a navigation system according to an embodiment of the present disclosure.

FIG. 5A and FIG. 5B illustrate a process of acquiring front and rear camera parameters according to an embodiment of the present disclosure. Specifically, FIG. 5A illustrates the process of deriving extrinsic parameters using the camera coordinate system.

FIG. 5B illustrates the process of deriving intrinsic parameters of the wide-angle camera.

FIG. 6 illustrates a process of estimating the height of the horizon using the V_{y} coordinate value of a vanishing point according to an embodiment of the present disclosure.

FIG. 7A, FIG. 7B, and FIG. 7C illustrate results of reducing resources or improving processing capability compared to the same resources by adjusting the number of blocks in the region of interest according to an embodiment of the present disclosure. Specifically,

FIG. 7A illustrates a typical automatic exposure (AE) window implemented according to an existing approach. FIG. 7B illustrates an approach implemented using a new AE window.

FIG. 7C also illustrates an approach implemented using a new AE window.

FIG. 8A and FIG. 8B illustrate a result of improved recognition of the solar light source by adjusting the number of blocks in the region of interest according to an embodiment of the present disclosure. Specifically, FIG. 8A shows a typical AE region of interest implemented using an existing approach. FIG. 8B shows an AE region of interest reflecting a real-time tolerance compensation result.

FIG. 9A and FIG. 9B illustrate a result of recognizing the solar light source using brightness values of blocks in the region of interest according to an embodiment of the present disclosure. Specifically, FIG. 9A shows a scene of the external environment captured by the camera. FIG. 9B shows the AE region of interest reflecting a real-time tolerance compensation result.

FIG. 10A and FIG. 10B illustrate an example of backlight compensated image after recognition of backlighting according to an embodiment of the present disclosure.

Specifically, FIG. 10A shows the original image without backlight compensation. FIG. 10B shows a result of recognizing the solar light source and performing backlight compensation on each subject.

FIG. 11 is a flow diagram illustrating a process of determining backlight in a region of interest and performing backlight compensation based on classified situations according to an embodiment of the present disclosure.

FIG. 12 is a block diagram schematically showing a computing device that can be used to implement the method or apparatus according to the present disclosure.

### DETAILED DESCRIPTION

Hereinafter, some embodiments of the present disclosure are described in detail with reference to the accompanying drawings. In the following descriptions, like reference numerals designate like elements, although the elements are shown in different drawings. Further, in the following descriptions of some embodiments, a detailed description of known functions and configurations incorporated therein has been omitted for the purpose of clarity and for brevity.

Additionally, various terms, such as first, second, A, B, (a), (b), etc., are used solely to differentiate one component from the other and are not intended to imply or suggest the substances, order, or sequence of the components. Throughout the present disclosure, when a part ‘includes’ or ‘comprises’ a component, the part is meant to further include other components and not to exclude other components unless specifically stated to the contrary. The terms, such as ‘unit’, ‘module’, and the like, refer to one or more units for processing at least one function or operation, which may be implemented by hardware, software, or a combination thereof. When a controller, module, component, device, element, unit, or the like of the present disclosure is described as having a purpose or performing an operation, function, or the like, the controller, module, component, device, element, unit, or the like should be considered herein as being “configured to” meet that purpose or to perform that operation or function. Each controller, module, component, device, element, unit, and the like may separately embody or be included with a processor and a memory, such as a non-transitory computer readable media, as part of the apparatus.

The following detailed descriptions, together with the accompanying drawings, are intended to describe embodiments of the present disclosure and are not intended to represent the only embodiments in which the present disclosure may be practiced.

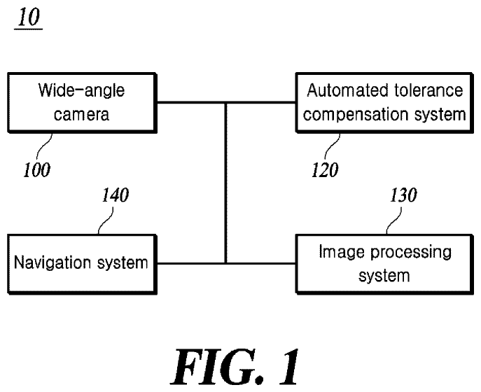

FIG. 1 is a block diagram briefly illustrating a backlight compensation apparatus according to an embodiment of the present disclosure.

The backlight compensation apparatus 10 according to an embodiment of the present disclosure may comprise at least one of a wide-angle camera 100, an automated tolerance compensation system 120, an image processing system 130, or a navigation system 140. Meanwhile, the constituting elements shown in FIG. 1 represent functionally distinct elements, and at least one constituting element may be implemented in an integrated form in an actual physical environment.

The wide-angle camera 100 may include at least one of a front camera, a rear camera, or a side camera mounted on the vehicle. The camera may include a mono camera, a stereo camera, and the like. The type and installation location of the camera may be changed and designed in various ways by those having ordinary skill in the art within the technical scope of the present disclosure.

The automated tolerance compensation system 120 is a system that generates a coherent top view image by synthesizing and correcting images captured by four cameras using various patterns and image synthesis algorithms when an around view monitoring (AVM) system is installed.

The image processing system 130 receives images from the wide-angle camera 100, processes the received images, and performs backlight compensation.

The navigation system 140 receives corrected images from the image processing system 130 and provides the received corrected images to the passengers.

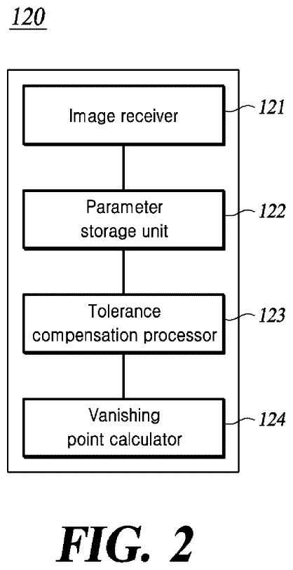

FIG. 2 is a block diagram illustrating an automated tolerance compensation system 120 according to an embodiment of the present disclosure.

The automated tolerance compensation system 120 may comprise at least one of an image receiver 121, a parameter storage unit 122, a tolerance compensation processor 123, or a vanishing point calculator 124. Meanwhile, the constituting elements shown in FIG. 2 represent functionally distinct elements, and at least one constituting element may be implemented in an integrated form in an actual physical environment.

Tolerance refers to the difference between the maximum and minimum values defined for a specific reference value. In other words, tolerance has the same meaning as the allowable error.

Tolerance compensation is one of the fundamental algorithms for Automatic Vehicle Monitoring (AVM) systems. The AVM is a system that captures the entire 360-degree surroundings of a vehicle using four cameras and displays the surroundings of the vehicle on one screen as if viewing the vehicle's surroundings from above. The AVM helps the passengers easily check the vehicle's surroundings without the need to open windows when it is difficult to see outside in cloudy or rainy weather and enables the passengers to identify obstacles in blind spots not visible in the vehicle's side-view mirrors. Thus, the risk of accidents may be reduced.

The Surround View Monitor (SVM) is a device that enables the passenger to see the front, rear, left, and right sides through four cameras mounted on the vehicle. The SVM system aims to improve the safety and convenience of vehicle operation by providing images around the vehicle to the driver when the vehicle is parked and driven at low speeds. The main functions of the SVM system include an image display function around the vehicle, a parking distance warning display function, and a tolerance compensation function.

The image receiver 121 receives images of the front, rear, left, and right sides of the vehicle from a wide-angle camera 100.

The parameter storage unit 122 acquires and stores actual extrinsic parameters of the camera with respect to design values in real-time and stores intrinsic parameters acquired from the manufacturing process.

The tolerance compensation processor 123 acquires the actual external parameters of the camera with respect to design values in real-time, which are influenced by external physical factors and tolerances.

The vanishing point calculator 124 estimates the y-direction pixel coordinate value of the horizon using the intrinsic and extrinsic parameters of the camera.

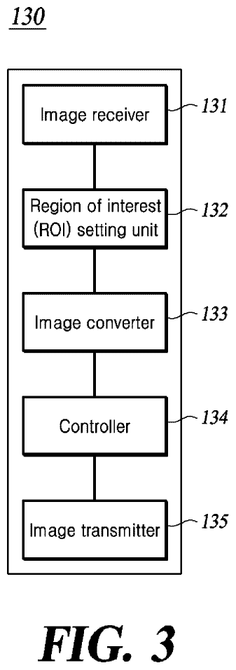

FIG. 3 is a block diagram illustrating an image processing system 130 according to an embodiment of the present disclosure.

The image processing system 130 may comprise at least one of an image receiver 131, a region of interest setting unit 132, an image converter 133, a controller 134, or an image transmitter 135. Meanwhile, the constituting elements shown in FIG. 3 represent functionally distinct elements, and at least one constituting element may be implemented in an integrated form in an actual physical environment.

The image receiver 131 receives images of the front and rear of the vehicle from the wide-angle camera 100.

The region of interest setting unit 132 receives the coordinate values of the horizon from the automate tolerance compensation system 120 and sets the region of interest based on the horizon.

The region of interest setting unit 132 accurately divides the region of interest window into a road region and a sky region using the coordinate values of the horizon estimated by reflecting the tolerance compensation result.

The image converter 133 converts RGB data for each pixel of the input image into YUV data.

Luminance is a measure of brightness of light radiated from a light source and is a value that indicates how bright the light source appears when an observer looks at the light source from a specific direction.

The controller 134 performs backlight compensation by partitioning the region of interest into a plurality of blocks, calculating the average luminance value for each of the plurality of image blocks, setting a block group that meets the conditions for recognizing the solar light source, and controlling the brightness of each block.

The controller 134 identifies only the region of interest included in the sky region, partitions the region of interest into a plurality of blocks, and adjusts the number of blocks in the region of interest to reduce resources required for image processing. The controller 134 may specify conditions for recognition of the solar light source using multiple region of interest (ROI) blocks within the same resource. When the conditions are further specified, the accuracy of solar light source recognition is improved.

Specifically, the controller 134 classifies a plurality of blocks into four groups to select a plurality of block groups that satisfy the conditions for solar light source recognition. Blocks with an average luminance value of data equal to or higher than a first value within the overall brightness distribution of the image are classified into a first group. Blocks with an average luminance value of data less than the first value and higher than or equal to a second value within the overall brightness distribution of the image are classified into a second group. Blocks with an average luminance value of data less than the second value and higher than or equal to a third value within the overall brightness distribution of the image are classified into a third group. Blocks with an average brightness value of data less than the third value within the overall brightness distribution of the image are classified into a fourth group. For example, the first value is defined as 95%, the second value as 90%, and the third value as 20%. The defined average luminance value is not limited to the specific values above.

To meet the conditions for solar light source recognition, blocks belonging to the first group should be adjacent to each other by more than a first threshold, blocks belonging to the first group should be adjacent only to blocks belonging to the second group, blocks belonging to the second group should be adjacent to each other by a second threshold, and blocks belonging to the second group should always be adjacent to blocks belonging to the first group. Blocks belonging to the first group adjacent to the blocks belonging to the third group are excluded from the determination conditions. Blocks belonging to the second group are adjacent to blocks belonging to the first group on only one side. Even when the brightness of the first group is higher than that of the third group by a specific threshold, the first group is recognized as the solar light source. The first threshold is defined as 5, and the second threshold is defined as 15. However, the thresholds are not limited to the specific values above. Blocks belonging to the first group and blocks belonging to the second group may have shapes with vertical and/or horizontal symmetry.

The controller 134 classifies backlight situations into four types: first situation, second situation, third situation, or fourth situation.

The first situation corresponds to a case where the number of neighboring blocks belonging to the first group is greater than or equal to the first threshold, and the number of neighboring blocks belonging to the second group is greater than or equal to the second threshold. In another embodiment of the present disclosure, blocks belonging to the first group may have a shape with vertical and/or horizontal symmetry. In yet another embodiment of the present disclosure, blocks belonging to the second group may have a shape with vertical and/or horizontal symmetry. The first threshold is defined as 5, and the second threshold is defined as 15. However, the thresholds are not limited to the specific values above. The first situation corresponds to a very strong backlight condition.

The second situation corresponds to a case where the number of neighboring blocks belonging to the first group is greater than or equal to the first threshold, the number of neighboring blocks belonging to the second group is less than the second threshold, and the brightness ratio exceeds a first ratio. In another embodiment of the present disclosure, blocks belonging to the first group may have a shape with vertical and/or horizontal symmetry. In yet another embodiment of the present disclosure, blocks belonging to the second group may have a shape with vertical and/or horizontal symmetry. The first ratio is a value obtained by dividing the average brightness of the fourth group by the average brightness of the first group, which is 0.5. However, it should be noted that the first ratio is not limited to the specific value above. The second situation corresponds to a weak backlight condition.

The third situation corresponds to a case where the number of neighboring blocks belonging to the first group is greater than or equal to the first threshold, the number of neighboring blocks belonging to the second group is less than the second threshold, and the brightness ratio is less than or equal to the first ratio and exceeds a second ratio. In another embodiment of the present disclosure, blocks belonging to the first group may have a shape with vertical and/or horizontal symmetry. In yet another embodiment of the present disclosure, blocks belonging to the second group may have a shape with vertical and/or horizontal symmetry. The number of blocks and the average brightness are not limited to the specific values above. The second ratio is a value obtained by dividing the average brightness of the fourth group by the average brightness of the first group, which is 0.3. However, it should be noted that the second ratio is not limited to the specific value above. The third situation corresponds to a backlight condition of intermediate level.

The fourth situation corresponds to a case where the number of neighboring blocks belonging to the first group is greater than or equal to the first threshold, the number of neighboring blocks belonging to the second group is less than the second threshold, and the brightness ratio is less than or equal to the second ratio. In another embodiment of the present disclosure, blocks belonging to the first group may have a shape with vertical and/or horizontal symmetry. In yet another embodiment of the present disclosure, blocks belonging to the second group may have a shape with vertical and/or horizontal symmetry. However, it should be noted that the ratio is not limited to the specific value above. The fourth situation corresponds to a strong backlight condition.

When determining the backlight condition as the first situation, the controller 134 lowers the luminance value of the first group by 10%, lowers the luminance value of the second group by 5%, increases the luminance value of the third group by 15%, and increases the luminance value of the fourth group by 30%.

When determining the backlight condition as the second situation, the controller 134 increases the luminance value of the fourth group by 10%.

When determining the backlight condition as the third situation, the controller 134 increases the luminance value of the third group is increased by 5% and increases the luminance value of the fourth group by 20%.

When determining the backlight condition as the fourth situation, the controller 134 increases the luminance value of the third group by 10% and increases the luminance value of the fourth group by 25%. Meanwhile, the numerical values for adjusting the brightness value of each group and situation are not limited to the specific examples above.

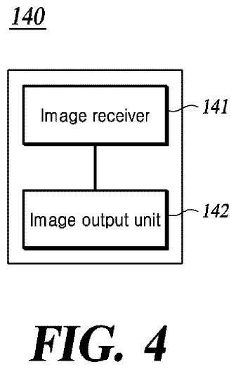

FIG. 4 is a block diagram illustrating a navigation system 140 according to an embodiment of the present disclosure.

The navigation system 140 may comprise at least one of an image receiver 141 or an image output unit 142.

The image receiver 141 may receive real-time images through wired or wireless communication. Also, the image receiver 141 may receive the final backlight compensated image from the image processing system 130.

The image output unit 142 displays the final backlight compensated image to the passenger. The passenger may visually check the image output by the image output unit 142 through the display or the monitor provided in the vehicle. The passenger may quickly respond to driving and parking environments by checking the backlight compensated images.

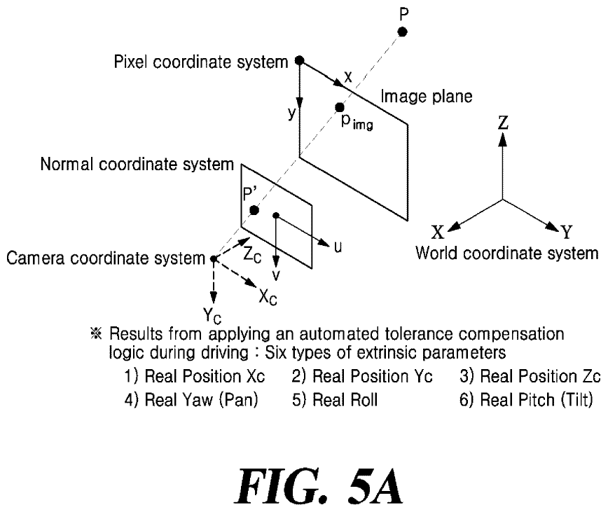

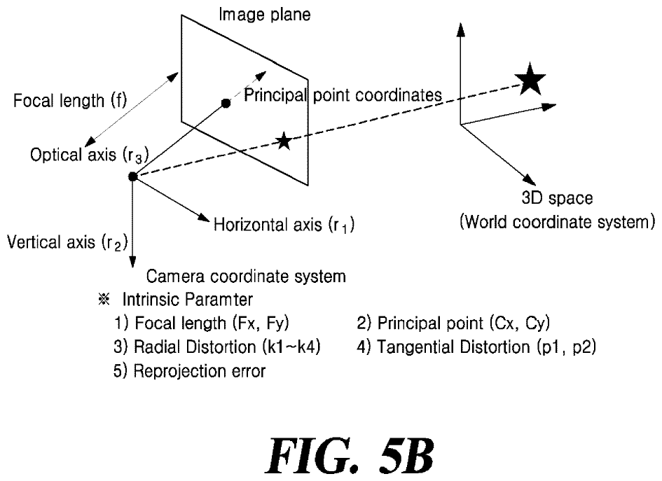

FIG. 5A and FIG. B illustrate a process of acquiring front and rear camera parameters according to an embodiment of the present disclosure.

FIG. 5A illustrates the process of deriving extrinsic parameters using the camera coordinate system.

The camera extrinsic parameters newly acquired in real-time through automated tolerance compensation during driving are stored in the parameter storage unit 122. The extrinsic parameters reflect the actual location of the camera rather than its design specifications.

FIG. 5B illustrates the process of deriving intrinsic parameters of the wide-angle camera 100.

The intrinsic parameters are acquired with respect to the camera coordinate system using the focal length, principal point, and optical axis, where the acquired actual intrinsic parameters are stored in the parameter storage unit 122.

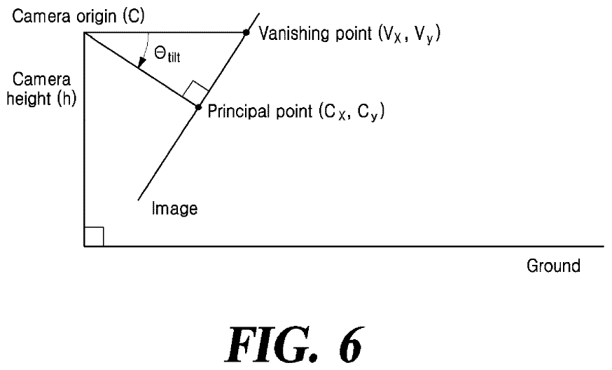

FIG. 6 illustrates a process of estimating the height of the horizon using the V_{y} coordinate value of a vanishing point according to an embodiment of the present disclosure.

The Y coordinate values of the vanishing point and the horizon are calculated using the camera parameters obtained from FIG. 5 and Eq. 1. a tan 2 is a bivariate function, which calculates the absolute angle between two points within the four quadrants.

$${θ}_{tilt} = atan 2 ( {V}_{y} - {C}_{y} , {F}_{y} ) \qquad [ Eq . 1 ]$$

In the equation above, F_{y} represents the distance along the y-axis from the camera lens center to the image sensor, where F_{y} always satisfies that F_{y}>0.

$${V}_{y ( real )} = {F}_{y ( real )} \times tan {θ}_{( real tilt )} + {C}_{y ( real )} \qquad [ Eq . 2 ]$$

If the vanishing point is formed above the optical axis, V_{y}−C_{y}>0, which establishes Eq. 2.

$${V}_{y ( real )} = {F}_{y ( real )} \times tan ( {θ}_{( real tilt )} - π ) + {C}_{y ( real )} \qquad [ Eq . 3 ]$$

If the vanishing point is formed below the optical axis, V_{y}−C_{y}<0, which establishes Eq. 3. The procedures of deriving Eqs. 2 and 3 based on the sign of V_{y}−C_{y} are well-known in the technical field to which the present disclosure belongs, and thus detailed descriptions have been omitted.

$${V}_{y ( real )} = {C}_{y ( real )} \qquad [ Eq . 4 ]$$

If the vanishing point coincides with the principal point, and V_{y}−C_{y}=0, the y-coordinate of the horizon becomes C_{y}. Therefore, the height of the horizon may be estimated using the V_{y} (real) coordinate value, which is the Y-coordinate of the vanishing point in the equation above.

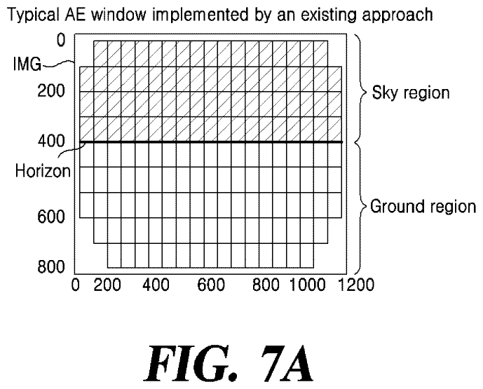

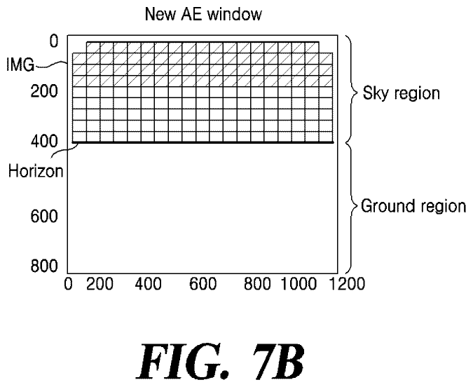

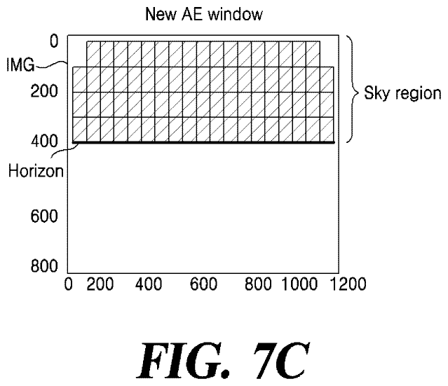

FIG. 7A, FIG. 7B, and FIG. 7C illustrate results of reducing resources or improving processing capability compared to the same resources by adjusting the number of blocks in the region of interest according to an embodiment of the present disclosure. Because the controller 134 determines only the region of interest belonging to the sky region, it is possible to reduce the resources required for image processing by reducing and adjusting the number of blocks. Also, it is possible to refine the conditions for recognizing the sun by using more ROI blocks within the same resource constraints.

FIG. 7A illustrates a typical automatic exposure (AE) window implemented according to an existing approach. The total number of blocks in the sky region is 74, which occupies 50% of the resources.

FIG. 7B illustrates an approach implemented using a new AE window. Compared to 7A, blocks are categorized more precisely. The number of blocks belonging to the sky region is 169, which occupies 50% of the resources. By increasing the number of partitions of blocks belonging to the sky region, it is possible to use more than twice the number of blocks compared to the existing approach. Although the same resources are used as the previous ROI, more than twice the number of ROI blocks may be used.

FIG. 7C also illustrates an approach implemented using a new AE window. Compared to 7A, the number of blocks is reduced. The number of blocks belonging to the sky region is 74, which occupies 25% of the resources. Although the number of blocks corresponding to the sky region is the same as in the previous ROI, only half the resources may be secured.

The controller 134 may reduce the required resources by adjusting the number of blocks in the entire region of interest.

The region of interest setting unit 132 may divide the region of interest window into a road region and a sky region using the coordinate values of the horizon estimated by employing the tolerance compensation result.

Because the controller 134 determines only the exact region of interest belonging to the sky region, processing capability based on the same resources may be improved by further partitioning the number of ROI blocks, or required resources may be reduced by decreasing the number of ROI blocks.

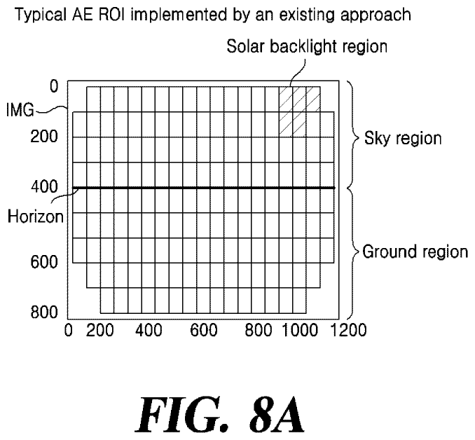

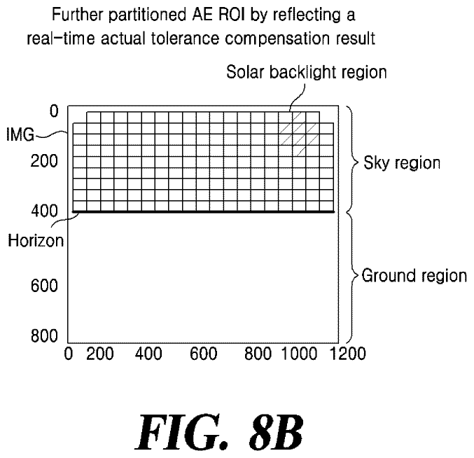

FIG. 8A and FIG. 8B illustrate a result of improved recognition of the solar light source by adjusting the number of blocks in the region of interest according to an embodiment of the present disclosure.

FIG. 8A shows a typical AE region of interest implemented using an existing approach.

The solar backlight region is indicated by blocks with diagonal lines. The region of interest in the existing approach has a problem in that it is difficult to recognize the shape of the sun because of the large block size.

FIG. 8B shows an AE region of interest reflecting a real-time tolerance compensation result.

The solar backlight region is indicated by blocks with diagonal lines. When blocks in the region of interest are further partitioned by reflecting the tolerance compensation result, blocks corresponding to the solar light source form a symmetrical shape. This allows the shape of the sun to be accurately recognized.

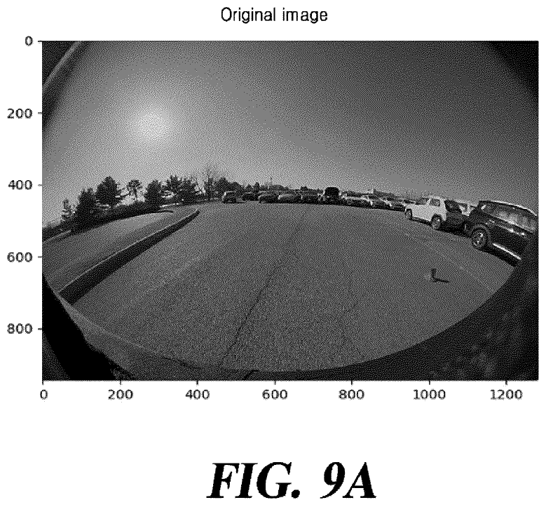

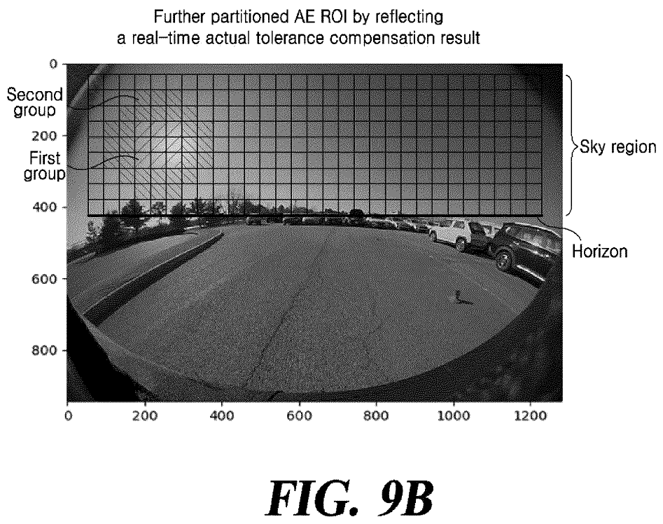

FIG. 9A and FIG. 9B illustrate a result of recognizing the solar light source using brightness values of blocks in the region of interest according to an embodiment of the present disclosure. The sun light source is indicated by blocks with two different diagonal lines. A first group comprises blocks with diagonal lines pointing downward to the left, and a second group comprises blocks with diagonal lines pointing downward to the right.

FIG. 9A shows a scene of the external environment captured by the camera.

FIG. 9B shows the AE region of interest reflecting a real-time tolerance compensation result. The controller 134 may set a block group that meets the conditions for recognition of the solar light source. Blocks belonging to the first group and blocks belonging to the second group are adjacent to each other to form the solar light source. Because the brightness of the sun decreases from the center of the light source to the periphery, further partitioning of the region of interest blocks based on the real-time tolerance compensation result may enable distinguishing and precisely recognizing the central and peripheral regions of the sun using blocks adjacent to high-luminance blocks and non-high-luminance blocks compared to the overall brightness of the image.

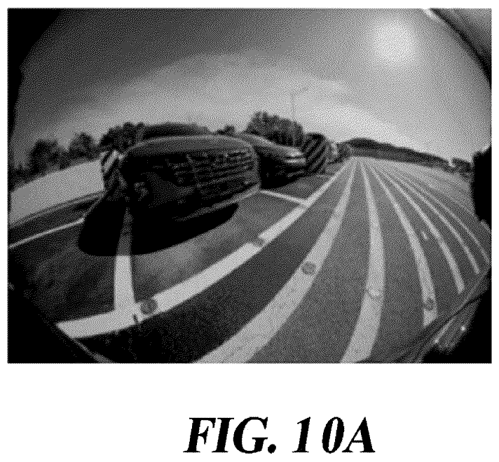

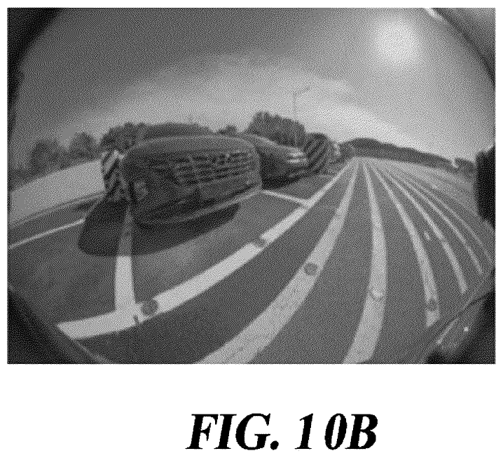

FIG. 10A and FIG. 10B illustrate an example of backlight compensated image after recognition of backlighting according to an embodiment of the present disclosure. FIG. 10A shows the original image without backlight compensation.

FIG. 10B shows a result of recognizing the solar light source and performing backlight compensation on each subject.

The controller 134 may perform at least one of tone mapping, frame interpolation, or motion deblurring.

Tone mapping refers to the process of mapping a high dynamic range (HDR) image to a low dynamic range (LDR) image. Tone mapping may be carried out using a global tone mapping method that performs tone mapping using only one tone mapping operator for the entire image or a local tone mapping method that performs tone mapping on each pixel in the image according to the corresponding pixel value and pixel values of surrounding pixels.

Frame interpolation refers to the process of raising the frame of an existing video or a real-time rendered video.

Motion deblurring refers to the process of removing distinct stripes of fast-moving objects in consecutive frames of a video and an animation or in a still image.

The controller 134 recognizes the backlight included in the image and then performs brightness compensation of the image affected by the backlight using the tone mapping technique. Passengers may easily distinguish subjects from backlight-compensated images.

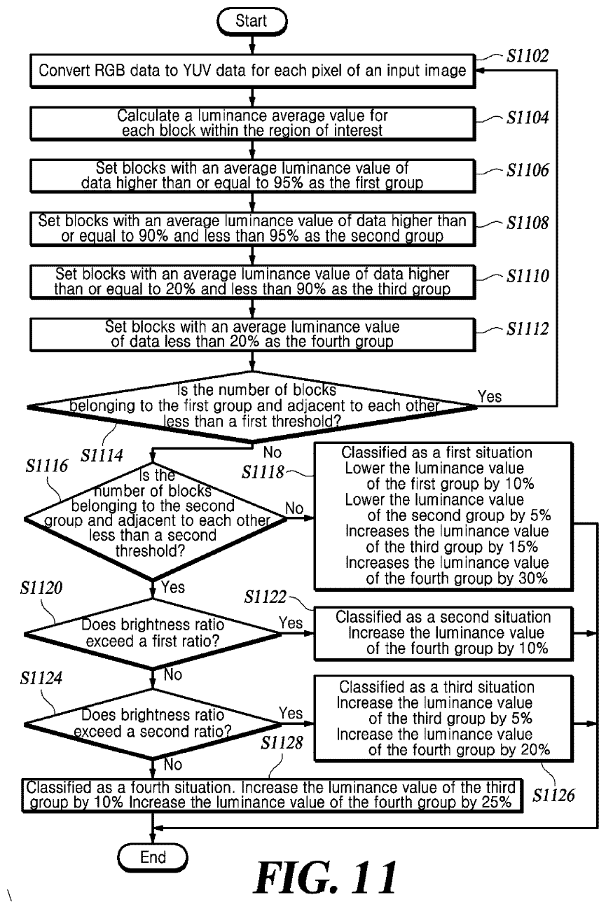

FIG. 11 is a flow diagram illustrating a process of determining backlight in a region of interest and performing backlight compensation based on classified situations according to an embodiment of the present disclosure.

The image converter 133 converts RGB data to YUV data for each pixel of an input image (S1102).

The controller 134 calculates a luminance average value for each block within the region of interest that belongs to the sky region (S1104).

Blocks with an average luminance value of data higher than or equal to 95% of the overall brightness distribution are set as the first group (S1106).

Blocks with an average luminance value of data higher than or equal to 90% and less than 95% of the overall brightness distribution are set as the second group (S1108).

Blocks with an average luminance value of data higher than or equal to 20% and less than 90% of the overall brightness distribution are set as the third group (S1110).

Blocks with an average luminance value of data less than 20% of the overall brightness distribution are set as the fourth group (S1112).

The controller 134 determines whether the number of blocks belonging to the first group and adjacent to each other is less than a first threshold (S1114). When the number of the blocks belonging to the first group and adjacent to each other is less than the first threshold (Yes in S1114), data are transmitted to the image converter 133 (S1102).

When the number of the blocks belonging to the first group and adjacent to each other is greater than or equal to the first threshold (No in S1114), the controller 134 determines whether the number of blocks belonging to the second group and adjacent to each other is less than a second threshold (S1116).

When the number of the blocks belonging to the first group and adjacent to each other is greater than or equal to the first threshold, and the number of the blocks belonging to the second group and adjacent to each other is greater than or equal to the second threshold (No in S1116), the corresponding situation is classified as the first situation.

The controller 134 lowers the luminance value of the first group by 10%, lowers the luminance value of the second group by 5%, increases the luminance value of the third group by 15%, and increases the luminance value of the fourth group by 30% (S1118).

When the number of the blocks belonging to the first group and adjacent to each other is greater than or equal to the first threshold, and the number of the blocks belonging to the second group and adjacent to each other is less than the second threshold (No in S1116), the controller 134 determines whether the brightness ratio exceeds the first ratio (S1120).

The brightness ratio is a value obtained by dividing the average brightness of the fourth group by the average brightness of the first group. When the brightness ratio exceeds the first ratio (Yes in S1120), the corresponding case is classified as the second situation.

When the current case is classified as the second situation, the controller 134 increases the luminance value of the fourth group by 10% (S1122).

When the brightness ratio does not exceed the first ratio (No in S1120), the controller 134 determines whether the brightness ratio exceeds the second ratio (S1124).

When the brightness ratio is less than or equal to the first ratio and exceeds the second ratio (Yes in S1124), the corresponding case is classified as the third situation. The controller 134 increases the luminance value of the third group by 5% and increases the luminance value of the fourth group by 20% (S1126).

When the brightness ratio is less than or equal to the second ratio (No in S1124), the corresponding case is classified as the fourth situation. The controller 134 increases the luminance value of the third group by 10% and increases the luminance value of the fourth group by 25% (S1128).

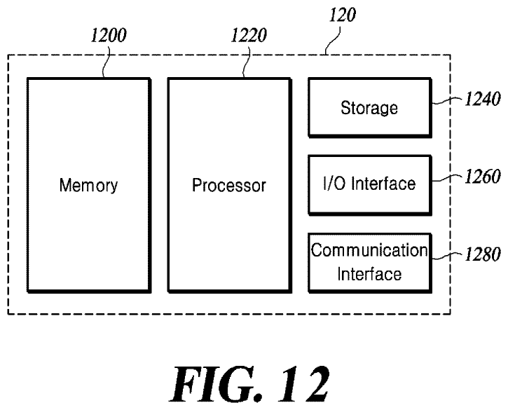

FIG. 12 is a block diagram schematically showing a computing device that can be used to implement the method or apparatus according to the present disclosure.

The computing device 120 may include at least one of a memory 1200, a processor 1220, a storage 1240, an input/output interface 1260, or a communication interface 1280. The computing device 120 may structurally and/or functionally include at least one of the wide-angle camera 100, automated tolerance compensation system 120, the image processing system 130, or navigation system 140. The computing device 120 may be a stationary computing device, such as a desktop computer, a server, and an AI accelerator, and may be a mobile computing device, such as a laptop computer and a smartphone.

The memory 1200 may store a program that causes the processor 1220 to perform method or operations according to various embodiments of the present disclosure. For example, the program may include a plurality of instructions executable by the processor 1220, and the method shown in FIG. 11 may be performed by the processor 1220 executing the plurality of instructions.

The memory 1200 may be a single memory or a plurality of memories. In this case, information required to perform methods or operations according to various embodiments of the present disclosure may be stored in a single memory or stored in a plurality of memories in a distributed manner. When the memory 1200 is configured as a plurality of memories, the plurality of memories may be physically separated.

The memory 1200 may include at least one of a volatile memory or a non-volatile memory. The volatile memory includes a static random access memory (SRAM) or a dynamic random access memory (DRAM), and the non-volatile memory includes a flash memory.

The processor 1220 may include at least one core capable of executing at least one instruction. The processor 1220 may execute instructions stored in the memory 1200. The processor 1220 may be a single processor or a plurality of processors.

The storage 1240 maintains stored data even if power supplied to the computing device 120 is cut off. For example, the storage 1240 may include a non-volatile memory or may include storage media, such as a magnetic tape, an optical disk, and a magnetic disk.

The program stored in the storage 1240 may be loaded into the memory 1200 before being executed by the processor 1220. The storage 1240 may store files written in a program language, and a program created from a file by a compiler or the like may be loaded into the memory 1200. The storage 1240 may store data to be processed by processor 1220 and/or data processed by processor 1220.

The input/output interface 1260 may include an input device, such as a keyboard and a mouse and may include an output device, such as a display device and a printer. A user may trigger execution of a program by the processor 1220 and/or check processing results of the processor 1220 through the input/output interface.

The communication interface 1280 may provide access to external networks. For example, the computing device 120 may communicate with other devices through the communication interface 1280.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely intended to describe the technical idea of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the present disclosure is not limited by the illustrations. Accordingly, those having ordinary skill should understand that the scope of the present disclosure should not be limited by the above explicitly described embodiments but by the claims and equivalents thereof.

What is claimed is:

1. A backlight compensation apparatus comprising:
at least one memory storing instructions; and
at least one processor configured to execute the instructions,
wherein, by executing the instructions, the at least one processor is configured to:
receive images from a camera by an in-vehicle system,
estimate a position of horizon in the images using intrinsic and extrinsic parameters of the camera,
set a region of interest (ROI) based on the position of the horizon,
partition the ROI into a plurality of blocks and measure an average luminance value for each of the plurality of blocks,
group the blocks into a plurality of block groups based on the average luminance value of each block,
determine a backlight condition of the ROI according to a predetermined average luminance value for each block among the plurality of block groups, and
adjust a plurality of block luminance values according to the backlight condition of the ROI.

2. The apparatus of claim 1, wherein the at least one processor is configured to classify the blocks into a first group, a second group, a third group, and a fourth group.

3. The apparatus of claim 2, wherein the at least one processor is configured to classify the blocks into the first group when the average luminance value of the blocks is higher than or equal to a predetermined first value,
wherein the at least one processor is configured to classify the blocks into the second group when the average luminance value of the blocks is less than the predetermined first value and higher than or equal to a predetermined second value,
wherein the at least one processor is configured to classify the blocks into the third group when the average luminance value of the blocks is less than the predetermined second value and higher than or equal to a predetermined third value, and
wherein the at least one processor is configured to classify the blocks into the fourth group when the average luminance value of the blocks is less than the predetermined third value.

4. The apparatus of claim 2, wherein the at least one processor is configured to classify backlight situations into a first situation when the number of neighboring blocks belonging to the first group is larger than or equal to a predetermined first threshold, and the number of neighboring blocks belonging to the second group is larger than or equal to a predetermined second threshold.

5. The apparatus of claim 4, wherein the at least one processor is configured to classify the backlight situations into a second situation when the number of neighboring blocks belonging to the first group is larger than or equal to the predetermined first threshold, the number of neighboring blocks belonging to the second group is less than the predetermined second threshold, and a brightness ratio obtained by dividing average brightness of the fourth group by average brightness of the first group exceeds a predetermined first ratio.

6. The apparatus of claim 5, wherein the at least one processor is configured to classify backlight situations into a third situation when the number of neighboring blocks belonging to the first group is larger than or equal to the predetermined first threshold, the number of neighboring blocks belonging to the second group is less than the predetermined second threshold, and the brightness ratio is less than or equal to the predetermined first ratio and exceeds a predetermined second ratio, and
wherein the at least one processor is configured to classify backlight situations into a fourth situation when the number of neighboring blocks belonging to the first group is larger than or equal to the predetermined first threshold, the number of neighboring blocks belonging to the second group is less than the predetermined second threshold, and the brightness ratio is less than or equal to the predetermined second ratio.

7. The apparatus of claim 4, wherein, in the first situation, the at least one processor is configured to adjust luminance values of the first to fourth groups.

8. The apparatus of claim 5, wherein, in the second situation, the at least one processor is configured to adjust luminance value of the fourth group.

9. The apparatus of claim 6, wherein, in the third situation, the at least one processor is configured to adjust luminance values of the third and fourth groups, and
wherein, in the fourth situation, the at least one processor is configured to adjust luminance values of the third and fourth groups.

10. A method for implementing a backlight compensation apparatus, the method comprising:
receiving images from a camera by an in-vehicle system;
estimating a position of horizon in the images using intrinsic and extrinsic parameters of the camera;
setting a region of interest (ROI) based on the position of the horizon;
partitioning the ROI into a plurality of blocks and measure an average luminance value for each of the plurality of blocks;
grouping the blocks into a plurality of block groups based on the average luminance value of each block;
determining a backlight condition of the ROI according to a predetermined average luminance value for each block among the plurality of block groups; and
adjusting a plurality of block luminance values according to the backlight condition of the ROI.

11. The method of claim 10, further comprising:
classifying the plurality of block groups into a first group, a second group, a third group, and a fourth group.

12. The method of claim 11, further comprising:
classifying the blocks into the first group when the average luminance value of the blocks is higher than or equal to a predetermined first value;
classifying the blocks into the second group when the average luminance value of the blocks is less than the predetermined first value and higher than or equal to a predetermined second value;
classifying the blocks into the third group when the average luminance value of the blocks is less than the predetermined second value and higher than or equal to a predetermined third value; and
classifying the blocks into the fourth group when the average luminance value of the blocks is less than the predetermined third value.

13. The method of claim 11, further comprising:
classifying backlight situations into a first situation when the number of neighboring blocks belonging to the first group is larger than or equal to a predetermined first threshold, and the number of neighboring blocks belonging to the second group is larger than or equal to a predetermined second threshold.

14. The method of claim 13, further comprising:
classifying the backlight situations into a second situation when the number of neighboring blocks belonging to the first group is larger than or equal to the predetermined first threshold, the number of neighboring blocks belonging to the second group is less than the predetermined second threshold, and a brightness ratio obtained by dividing average brightness of the fourth group by average brightness of the first group exceeds a predetermined first ratio.

15. The method of claim 14, further comprising:
classifying backlight situations into a third situation when the number of neighboring blocks belonging to the first group is larger than or equal to the predetermined first threshold, the number of neighboring blocks belonging to the second group is less than the predetermined second threshold, and the brightness ratio is less than or equal to the predetermined first ratio and exceeds a predetermined second ratio; and
wherein classifying backlight situations into a fourth situation when the number of neighboring blocks belonging to the first group is larger than or equal to the predetermined first threshold, the number of neighboring blocks belonging to the second group is less than the predetermined second threshold, and the brightness ratio is less than or equal to the predetermined second ratio.

16. The method of claim 13, further comprising:
when a current situation is classified as the first situation, adjusting luminance values of the first to fourth groups.

17. The method of claim 14, further comprising:
when a current situation is classified as the second situation, adjusting luminance value of the fourth group.

18. The method of claim 15, further comprising:
when a current situation is classified as the third situation, adjusting luminance values of the third and fourth groups; and
when the current situation is classified as the fourth situation, adjusting luminance values of the third and fourth groups.
